(19) United States
(12) Patent Application Publication
(10) Pub. No.: US 2012/0198646 A1
(43) Pub. Date: Aug. 9, 2012

(54) WINDSHIELD WIPER WITH SEVERAL WIPER LIPS AND WITH AN INTEGRATED WIPING WATER DUCT

(75) Inventors: Fabian KEMPFER, Herdecke (DE); Christian NEUBERT, Ruesselsheim (DE); Claus WESTENBERGER, Lindenfels (DE)

(73) Assignee: GM GLOBAL TECHNOLOGY OPERATIONS LLC, Detroit, MI (US)

(21) Appl. No.: 13/368,711

(22) Filed: Feb. 8, 2012

(30) Foreign Application Priority Data
Feb. 9, 2011 (DE) 10 2011 010 708.8

(51) Int. Cl. B60S 1/48

(52) U.S. Cl. 15/250.04

(57) ABSTRACT

A windshield wiper arrangement is provided for a motor vehicle with at least one movably mounted wiper arm on which at least one flexible wiper lip is arranged, which has an integrated fluid-conducting duct for acting upon a vehicle pane with a washing fluid.

### CROSS-REFERENCE TO RELATED APPLICATION

This application claims priority to German Patent Application No. DE 10 2011 010 708.8, filed Feb. 9, 2011, which is incorporated herein by reference in its entirety.

### TECHNICAL FIELD

The technical field relates to a windshield wiper arrangement for motor vehicles with at least one movably mounted wiper arm, which has at least one flexible wiper lip, which on putting the wiper arrangement into operation slides along on the outer side of an associated motor vehicle windowpane.

### BACKGROUND

The most varied of configurations and concepts exist for windshield wiper arrangements for motor vehicles. Established windshield wiper arrangements have at least one wiper arm, which slides along on for example a rear pane or windshield of a motor vehicle either in an oscillating or in a translatory displacement motion. To reduce dirt situated or collecting on the pane, provision is made in addition to spray a washing or cleaning fluid onto the pane and to clean the pane, which has been wetted with washing fluid, with the aid of the windshield wiper.

Established wiper arrangements make provision to provide the washing nozzles outside the wiper blades or respectively wiper arms of a windshield wiper, thus for example, on an engine hood or on a rear flap of the vehicle body. The nozzles provided for spraying the washing fluid are configured such that always as large an area section of the pane as possible is able to be wetted with washing fluid. However, this can have a disadvantageous effect on the visibility conditions for the vehicle occupants. Thus, with a spraying of a front windshield with washing fluid, always a certain period that is not insignificant can elapse until the wiper arms or wiper blades of the windshield wiper arrangement provide unobstructed visibility conditions again.

DE 37 16 697 A1 describes furthermore a windshield wiper with incorporated washing- and heating device. Therein, a windshield wiper is described with a U-shaped wiper lip of plastic material, which forms a space with direct contact to the pane, in which cleaning medium can flow in one or more directions along the pane. In addition, energy carriers and water with or without additive, water vapor or warm gas for cleaning the panes and/or for removal of the formation of ice on the pane can be introduced into the space formed from the U-shaped wiper lip.

In contrast, at least one objective is to provide an improved windshield wiper arrangement for motor vehicles, which even when a pane is acted upon with washing fluid only minimally impairs the visual field of the vehicle occupants. In addition, at least another objective is to reduce the consumption of washing fluid for a windshield wiper arrangement and alongside, and reduces the overall vehicle weight. Furthermore, other objectives, desirable features, and characteristics will become apparent from the subsequent summary and detailed description, and the appended claims, taken in conjunction with the accompanying drawings and this background.

### SUMMARY

A windshield wiper arrangement is designed for a motor vehicle. It has at least one movably mounted wiper arm, on which at least one flexibly constructed wiper lip is arranged. In the wiper lip itself, an integrated fluid-conducting duct is inserted for acting upon a vehicle pane with a washing fluid. The fluid-conducting duct is substantially surrounded in this area by the material forming the wiper lip. Washing fluid can only emerge in the region of individual outlet openings from the fluid-conducting duct, integrated into the wiper lip, in the direction of the vehicle pane that is to be cleaned.

By the wiper lip itself receiving a fluid-conducting function and by the washing fluid therefore being applied directly from the wiper lip onto the vehicle pane and being distributed thereby, on the one hand the consumption of washing fluid can be lowered and on the other hand impairment to the visual field for the vehicle occupants during a cleaning process can be reduced. Respectively, the area region of the vehicle pane is wetted with washing fluid, in or on which the wiper arm or respectively its wiper lip is directly situated.

Likewise, a distribution of the washing fluid can take place along the wiper arm or respectively the wiper lip via the fluid-conducting duct that is inserted or embedded in the wiper lip. Separate washing nozzles or spray nozzles for the washing fluid can therefore be advantageously dispensed with. In addition, through the immediately adjacent or respectively combined arrangement of fluid-conducting duct and wiper lip, a well-measured and locally limited wetting can take place of a vehicle pane that is to be cleaned.

According to a first embodiment, the at least one wiper lip and the fluid-conducting duct are connected with each other in one piece. Provision is made here in particular to integrate the fluid-conducting duct already during the manufacturing process of the wiper lip into the latter. For example, the wiper lip can be formed from rubber, an elastomer or a comparable flexible material for instance in the course of an injection molding, extrusion or extrusion molding process.

With a subsequent mounting of the wiper lip on a carrier structure of the windshield wiper arrangement, such as for example the wiper arm and on its fastening elements provided for attaching the wiper lip, at the same time also the fluid-conducting components of the windshield wiper arrangement are brought into their final mounting position. It is merely necessary to couple the wiper lip in a fluid-conducting manner with a washing fluid conveying pump arrangement.

According to an embodiment, provision is additionally made that the fluid-conducting duct extends in the longitudinal direction of the wiper lip in the region of a base section facing away from the free end of the wiper lip. The fluid-conducting duct preferably has a longitudinal extent here that corresponds to that of the wiper lip. Thus, over the entire longitudinal extent of the wiper lip, washing fluid can be applied onto the pane that is to be cleaned. By the fluid-conducting duct not extending on a front section facing the pane, but rather oppositely on a base section of the wiper lip, it can be achieved that the washing fluid emerging from the fluid-conducting duct develops freely in an intermediate space formed between the base section and the wiper lip, preferably also can expand in a diverging manner transversely to the squirting or spraying direction.

According to a further embodiment, provision is additionally made that the fluid-conducting duct has several outlet openings, spaced apart from each other in the longitudinal direction of the wiper lip, along the wiper lip or respectively along its base section. The outlet openings can be constructed as simple holes in the wall of the wiper lip base, which form an access to the fluid-conducting duct. Alternatively or additionally, the outlet openings for the washing fluid can, however, also be constructed as nozzles, in order to be able to influence or alter in a targeted manner the outflow behavior or spray behavior of the washing fluid. Individual spray nozzles can, for example, be embedded or inserted into the wiper lip material.

According to another embodiment, provision is additionally made that a distance of outlet openings and/or nozzles arranged adjacent to each other varies dependent on position along the longitudinal extent of the wiper lip. In this way, a pressure loss along the fluid-conducting duct or the wiping motion provided for the wiper lip can be accommodated. In addition to varying distances of adjacent outlet openings or nozzles, according to a further development additionally or alternatively hereto, provision can be further made to vary a diameter or an opening cross-section of the outlet openings and/or nozzles that are arranged adjacent to each other, dependent on position along the wiper lip or respectively along the wiper arm.

In this way, different pressure conditions within the fluid-conducting duct, but also the wiping motion provided for the wiper arm or respectively for the wiper lip can be accommodated. In the case of a wiper arm mounted in an oscillating manner, namely, the free end region of the wiper arm, facing away from the pivot axis, covers a much greater area segment than a wiper arm section lying close to the axis. In this respect, it proves to be advantageous if the distance, or respectively if the distances, between the nozzles or outlet openings, where applicable the opening cross-section thereof, is or respectively are selected such that the area sections of the pane to be cleaned which are to be covered by the wiper blade, with a different radial distance from the pivot axis of the wiper arm, are acted upon with washing fluid in an approximately homogeneous manner.

Thus, according to a further embodiment provision is made in particular that with a wiper arm that is mounted to be movable in an oscillating manner, the distance of outlet openings and/or nozzles, arranged adjacent in the longitudinal direction of the wiper lip, reduces towards the free end of the wiper arm. In this way, in particular at the regions of the wiper arm facing away from the oscillation axis, more washing fluid can be applied onto the pane than is the case at the foot of the wiper arm. In a corresponding manner, alternatively or additionally hereto, the opening cross-section or respectively the diameter of the outlet openings can be enlarged towards the free end of the wiper arm. It proves as a whole to be advantageous if the quantity of washing fluid that is to be deposited onto the pane by means of the fluid-conducting duct increases, for example, proportionally to the square of the distance to the oscillation axis of the wiper arm.

According to an embodiment, provision is made that in the region of a foot point of the wiper arm, the fluid-conducting duct can be coupled with a reservoir that can be filled with washing fluid. Accordingly, a supply of fluid to the fluid-conducting duct takes place from the mounting of the wiper arm. This means that a feed for the fluid-conducting duct is provided in the region of the pivot axis of the wiper arm. In this way, the supply of washing fluid can take place largely without hoses or suchlike fluid-conducting arrangements that are discernible from the exterior. By means of an internal conducting of fluid, integrated into the wiper arm, if applicable into its bearing, in addition a well-shaped design of the wiper arm can be realized.

According to a further embodiment, the windshield wiper arrangement has at least two wiper lips aligned parallel to each other, which are arranged on both sides of the fluid-conducting duct. The fluid-conducting duct is integrated or respectively embedded here into at least one of the two wiper lips or respectively into the material thereof. Advantageously, the fluid-conducting duct lies approximately centrally between the two wiper lips, in order to be able to achieve respectively unchanged cleaning effects irrespective of the direction of movement of the wiper arm.

In further embodiment, the at least two wiper lips are constructed in one piece, where they continue into each other in a shared base section. The fluid-conducting duct is inserted here in the corresponding base section or respectively is completely integrated into the base section. Provision is made here in particular that the two wiper lips are constructed as extensions of a rubber body projecting to the pane that is to be cleaned, which rubber body has a fluid-conducting duct for the washing fluid in a base section that connects the two wiper lips with each other.

By the fluid-conducting duct coming to lie between two wiper lips, which are, aligned parallel to each other, it can be achieved that the washing fluid emerging from the fluid-conducting duct remains substantially between the two wiper lips in the operation of the wiper. It is even conceivable here that, owing to the local spray action, limited by the wiper lips, a user scarcely notices anything of the actual wiping process.

According to a further embodiment, the two wiper lips can be fastened to a shared holding device of the wiper arm by means of the shared base section. By the base section, the fluid-conducting duct provided thereon and the at least two wiper lips constructed in one piece, a simple and effective mounting possibility can be created by merely fastening that base section to a fitting of the wiper arm which is provided for this. Hereby, also, an exchanging of the rubber body having the wiper lips, which is necessary in long-term operation, can be simplified. The arresting means provided for holding the wiper lips merely have to be released and a worn rubber body is to be replaced by a new one. Advantageously, here the fluid-conducting duct and the outlet openings or respectively washing nozzles provided for this for the washing fluid are also exchanged. Blocked or soiled outlet openings or nozzles can therefore be effectively and simply renewed in the course of a wiper blade exchange.

Irrespective of whether the windshield wiper arrangement is provided with one or with several wiper lips, according to a further embodiment the at least one wiper lip can be connected in one piece with a spoiler element, arranged facing way from the panes which are to be cleaned, or respectively can have such a spoiler element. The spoiler element typically has a wind-resistance surface constructed in the manner of a wedge, which in particular during high-speed travel takes care that the wiper arm does not rise from the vehicle pane and that it remains in contact therewith.

In the light of the above, according to a further embodiment, a motor vehicle is provided, which has at least one previously described windshield wiper arrangement. The windshield wiper arrangement here can be constructed selectively as a rear window wiper or as a front window wiper for the front windshield of a motor vehicle.

### BRIEF DESCRIPTION OF THE DRAWINGS

The present invention will hereinafter be described in conjunction with the following drawing figures, wherein like numerals denote like elements, and:

FIG. 1 a diagrammatic illustration of a wiper arm, provided with two wiper lips and an integrated fluid-conducting duct, in cross-section,

FIG. 2 an illustration, corresponding to FIG. 1, of a further embodiment; and

FIG. 3 a diagrammatic illustration of a wiper arm viewed from the vehicle pane.

### DETAILED DESCRIPTION

The following detailed description is merely exemplary in nature and is not intended to limit application and uses. Furthermore, there is no intention to be bound by any theory presented in the preceding background or summary or the following detailed description.

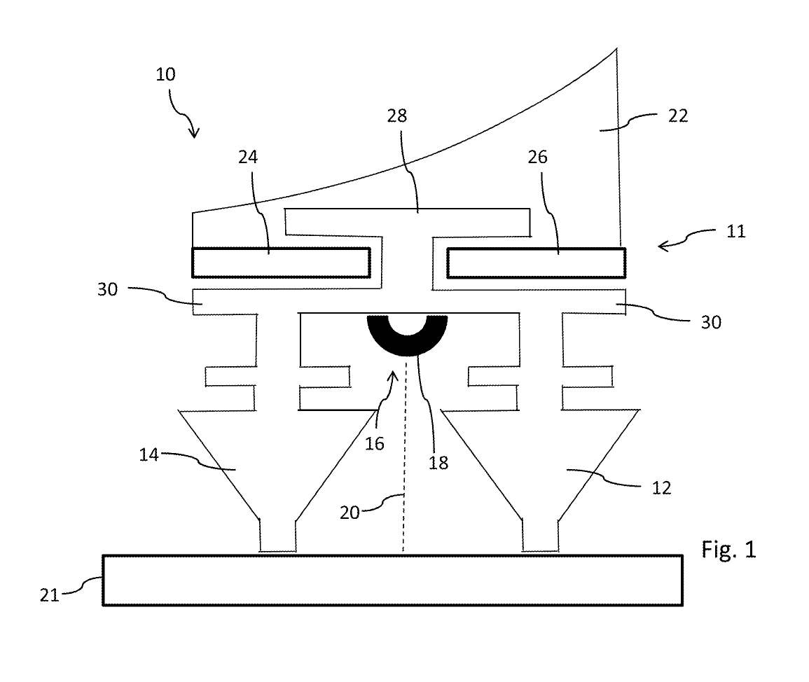

The windshield wiper arrangement 10 illustrated in cross-section in FIG. 1 has two downwardly projecting wiper lips 12, 14 of a flexible material, typically of natural or synthetic caoutchouc, rubber, or of an elastomer material. The two wiper lips 12, 14 are connected here in one piece with each other and continue upwards, facing away from a pane 21, which is to be cleaned, into a base section 30.

The base section 30 is constructed in the manner of a double T and has at its end section, lying at the top in FIG. 1, facing further away from the pane 21, a widened holding flange, or head 28. By means of this geometry a fitting or respectively fastening of the multi-wiper lip, rubber body is possible on two spring strips 24, 26 that are arranged adjacent to each other, at a distance from each other, which in turn are securely coupled with the wiper arm 11, which is mounted on a not explicitly illustrated rotation axis.

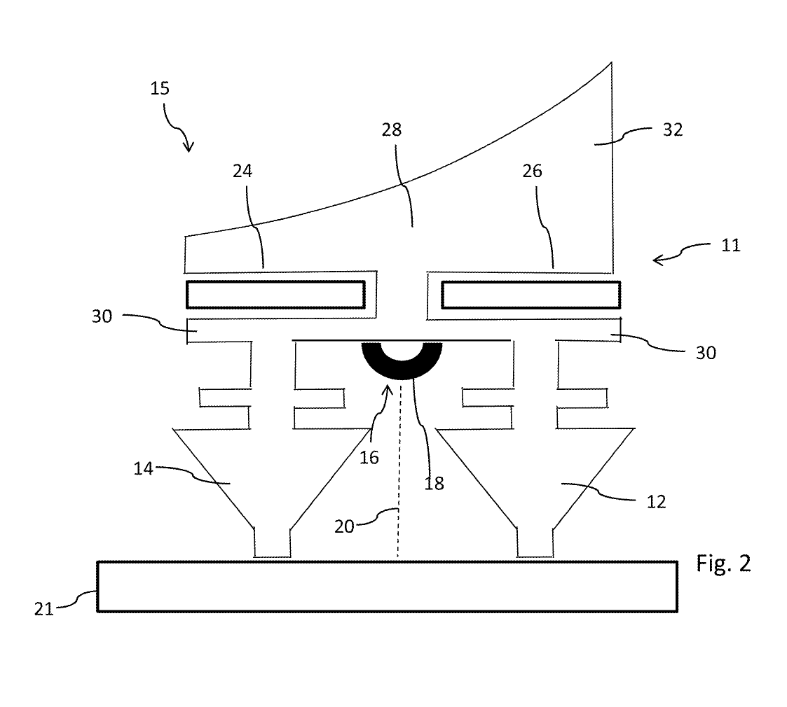

The multi-wiper lip rubber body has in the region of its base section 30, lying between the wiper lips 12, 14, an integrated fluid-conducting duct 18, which has outlet openings 16, arranged at a distance from each other, for the washing fluid which is to be conveyed in the duct 18. As indicated by dashed lines in FIG. 1 and FIG. 2, via the outlet openings 16 respectively a jet of washing fluid 20 can be applied onto the pane surface 21 between the two wiper lips 12, 14.

The windshield wiper arrangement illustrated in FIG. 1 has in addition a spoiler 22, constructed approximately in a wedge shape, which on the occurrence of a wind load presses the wiper arm 11 against the pane surface 21. By the rubber body comprising the two wiper lips 12, 14, the fastening head 28 and the base section 30 additionally having an integrated fluid-conducting washing fluid duct 18, the washing fluid which is to be applied onto the pane surface 21 can be applied solely locally and in a well-measured manner onto the pane 21, without noticeably impairing the visual field of the vehicle occupants.

As in particular two wiper lips 12, 14 are provided, laterally framing the fluid-conducting duct 18, irrespective of the respectively prevailing wiping direction of the wiper arm 11, directly after the spraying of the washing fluid 20 the pane 21 can be freed thereof again immediately. In modification of the windshield wiper arrangement 10 shown in FIG. 1, the windshield wiper arrangement 15 illustrated in FIG. 2 has a spoiler 32 constructed in one piece with the rubber body 12, 14, 30. Here, the holding flange 28, illustrated separately in FIG. 1, can be dispensed with in favor of the spoiler 32. The upper end section of this rubber body, facing away from the wiper lips 12, 14, is constructed at the same time as spoiler 32 and owing to its shape can contribute equally to the formation of a form-fitting connection with the spring strips 24, 26.

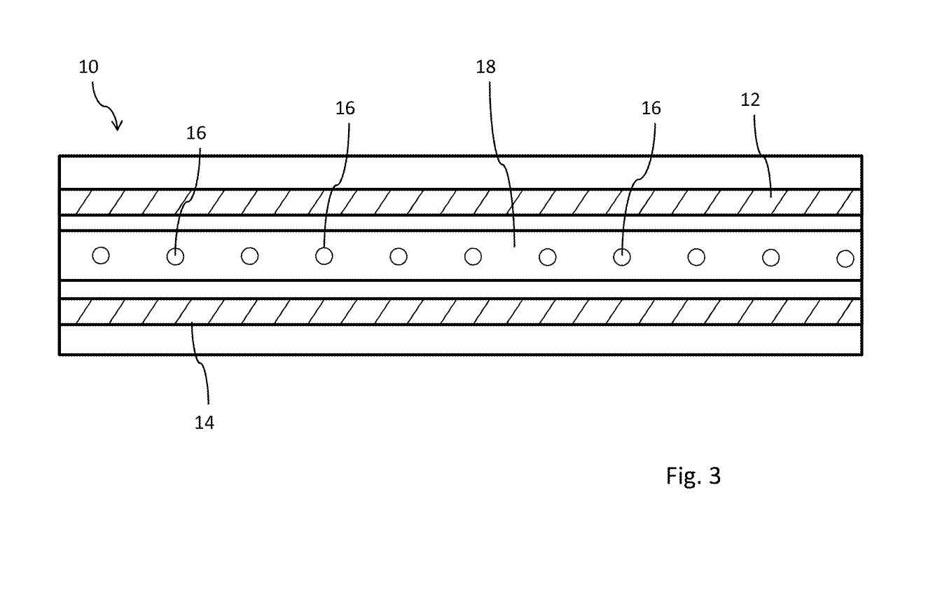

Finally, in FIG. 3 a view is shown of the wiper arm 11 from below. It can be seen here that the outlet openings 16 of the fluid-conducting duct 18 are arranged spaced apart from each other in the longitudinal direction of the wiper lips 12, 14 or respectively in the longitudinal direction of the fluid-conducting duct 18. Deviating from an equidistant arrangement of individual outlet openings 16 illustrated in FIG. 3, in particular in an oscillating mounted wiper blade provision can be made to reduce the distances of the outlet openings towards the pivot axis or respectively to increase these towards the free end of the wiper arm 11.

However, in the converse manner, provision may also be made to alter the size of the outlet openings, if applicable even to also alter the flow cross-section, able to be flowed through freely, of the flow duct 18 in the longitudinal direction of the duct 18, in order to obtain as constant an application of washing fluid as possible over the entire wiping zone of the pane 21 which is to be cleaned. Typically, towards the free end of the wiper arm 11 the outlet openings 16 for the washing fluid can be constructed larger than is the case for the outlet openings or nozzles 16 arranged closed to the axis.

In addition, the individual outlet openings 16 can be worked with high precision by means of laser or waterjet cutting into the rubber body, which has previously been produced, by an extrusion or extrusion molding process. Here, also, the hole spacing's can be adapted in a simple manner individually for various applications and wiper lip models. By the direct application of washing fluid 20 through the wiper blade or the wiper arm 11 itself, the cleaning medium or wiping water that is available can be used much more efficiently and sparingly. It is even conceivable here to reduce the reservoir of washing fluid, which is to be carried in the vehicle, for optimization of the installation space and to reduce the weight of the vehicle.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A windshield wiper arrangement for a motor vehicle, comprising:
at least one movably mounted wiper arm;
at least one flexible wiper lip is arranged on the at least one movably mounted wiper arm; and
an integrated fluid-conducting duct of the at least one flexible wiper lip that is configured to act on a vehicle pane with a washing fluid.

2. The windshield wiper arrangement according to claim 1, wherein the at least one flexible wiper lip is connected in one piece with the integrated fluid-conducting duct.

3. The windshield wiper arrangement according to claim 1, wherein in a region of a base section facing away from a free end of the at least one flexible wiper lip, the integrated fluid-conducting duct extends in a longitudinal direction of the at least one flexible wiper lip.

4. The windshield wiper arrangement according to claim 1, wherein the integrated fluid-conducting duct comprises a plurality of outlet openings spaced apart from each other in a longitudinal direction and configured for the washing fluid.

5. The windshield wiper arrangement according to claim 1, wherein the integrated fluid-conducting duct comprises a plurality of nozzles spaced apart from each other in a longitudinal direction and configured for the washing fluid.

6. The windshield wiper arrangement according to claim 4, wherein a distance between the plurality of outlet openings that are adjacent to each other varies dependent on a position along the at least one flexible wiper lip.

7. The windshield wiper arrangement according to claim 5, wherein a diameter of the plurality of nozzles arranged adjacent to each other varies dependent on position along the at least one flexible wiper lip.

8. The windshield wiper arrangement according to claim 1, wherein the at least one movably mounted wiper arm is mounted to move in an oscillating manner.

9. The windshield wiper arrangement according to claim 1,
wherein the at least one movably mounted wiper arm is mounted to move in an oscillating manner, and
wherein an opening cross-section of outlet openings arranged adjacent in a longitudinal direction increases towards a free end of the at least one movably mounted wiper arm.

10. The windshield wiper arrangement according to claim 1, wherein the integrated fluid-conducting duct in a region of a foot point of the at least one movably mounted wiper arm is coupled with a reservoir of washing fluid.

11. The windshield wiper arrangement according to claim 1, wherein at least two wiper lips aligned parallel to each other are arranged on both sides of the integrated fluid-conducting duct on the at least one movably mounted wiper arm.

12. The windshield wiper arrangement according to claim 11, wherein the at least two wiper lips are constructed in one piece and continue into each other in a base section having the integrated fluid-conducting duct.

13. The windshield wiper arrangement according to claim 11, wherein the at least two wiper lips fastened with a shared base section on a holder device of the at least one movably mounted wiper arm.

14. The windshield wiper arrangement according to claim 1, wherein the at least one flexible wiper lip is connected in one piece with a spoiler element arranged facing away from the vehicle pane.
